(19) United States
(12) Patent Application Publication
(10) Pub. No.: US 2008/0150364 A1
(43) Pub. Date: Jun. 26, 2008

(54) Power Supply System and Related Power Management Method for a Wireless Control Device

(76) Inventors: Chia-Hung Chen, Taipei Hsien (TW); Chih-Hung Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/853,803

(22) Filed: Sep. 11, 2007

(30) Foreign Application Priority Data
Dec. 21, 2006 (TW) 095148252

(51) Int. Cl. H02J 7/00

(52) U.S. Cl. 307/65; 320/101; 320/107; 322/100

(57) ABSTRACT

A power supply system for a wireless control device includes a plurality of power generation units for generating electric power, a power output unit coupled to the plurality of power generation units and a system circuit of the wireless control device for outputting electric power generated by the plurality of power generation units to the system circuit, and a microprocessor coupled to the plurality of power generation units for controlling the plurality of power generation units.

### BACKGROUND OF THE INVENTION

1. Field of the Invention

The present invention relates to a power supply system and related power management method for a wireless control device, and more particularly, to a power supply system and related power management method capable of generating operation power of a wireless control device by means of energy transformation through power generation devices such as mechanical energy transformation units, optical energy transformation units and so on.

2. Description of the Prior Art

From traditional functions, such as document processing and program operating, to modern multimedia, game playing, etc., a personal computer has become an important role in our daily life. Mouses and keyboards used for controlling the PC have improved too. With wireless communication technology, wired mouses and wired keyboards, as client ends, transmitting signals to a computer system, as a host end, can be gradually replaced by wireless mouses and keyboards.

Compared with wired mouses and wired keyboards, the wireless mouses and wireless keyboards that transmit control signals to a computer system could be through infrared ray, bluetooth and even radio frequency. Therefore, the wireless mouses and keyboards have to include independent power supply devices, such as batteries, for providing operation power. In this case, if the batteries run out, the wireless mouses and keyboards cannot be operated normally. In short, although the wireless mouses and keyboards can be used unrestrainedly, the power supply problem limits convenience of the wireless mouses and keyboards.

### SUMMARY OF THE INVENTION

It is therefore a primary objective of the present invention to provide a power supply system and related power management method for a wireless control device.

The present invention discloses a power supply system for a wireless control device comprising a plurality of power generation units for generating electric power, a power output unit coupled to the plurality of power generation units and a system circuit of the wireless control device for outputting power generated by the plurality of power generation units to the system circuit, and a microprocessor coupled to the plurality of power generation units for controlling the plurality of power generation units.

The present invention further discloses a power management method for a power supply system, which comprises a plurality of power generation units for generating power to a system circuit, comprising detecting a power supply state of the system circuit, and activating a power generation unit of the plurality of power generation units to generate power to the system circuit when power supply of the system circuit is insufficient.

The present invention further discloses a wireless mouse with power control comprising a system circuit for controlling a computer system through wireless transmission, and a power supply system comprising a plurality of power generation units for generating power, a power output unit coupled to the plurality of power generation units and the system circuit for outputting power generated by the plurality of power generation units to the system circuit, and a microprocessor coupled to the plurality of power generation units for controlling the plurality of power generation units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a power supply system for a wireless control device according to a preferable embodiment of the present invention.

FIG. 2 is a schematic diagram of a preferable embodiment of the power output unit.

FIG. 3 is a schematic diagram of a power management process according to an embodiment of the present invention.

FIG. 4 is a schematic diagram of a power management process according to the power management process of FIG. 3.

FIG. 5 is a schematic diagram of a wireless mouse with application of the present invention.

### DETAILED DESCRIPTION

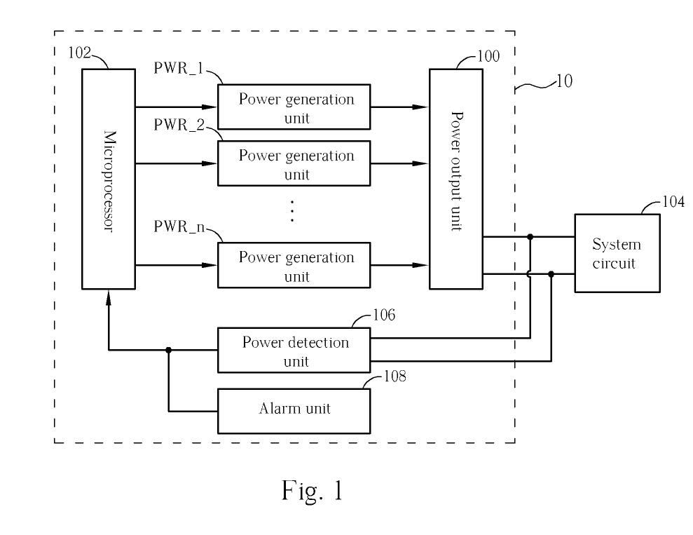

Please refer to FIG. 1, which is an illustration of a function block diagram of a power supply system 10 for a wireless control device according to a preferable embodiment of the present invention. The power supply system 10 is utilized for providing power supply to a system circuit 104 of the wireless control device, and comprises power generation units PWR_1˜PWR_n, a power output unit 100, a microprocessor 102, a power detection unit 106, and an alarm unit 108. The power generation units PWR_1 ˜PWR_n can be mechanical energy transformation units or optical energy transformation units, etc. for generating electric power by means of energy transformation. The power output unit 100 can output power generated by the power generation units PWR_1˜PWR_n to the system circuit 104, so that the system circuit 104 can perform related operations. The power detection unit 106 can detect magnitude of the power outputted by the power output unit 100 or power supply state of the system circuit 104, and transmit detection results to the microprocessor 102 and the alarm unit 108. The microprocessor 102 can control operations of the power generation units PWR_1˜PWR_n for activating or terminating specific power generation units. The alarm unit 108 can generate alarm signals like light, sound or vibration effect when the power supply of the system circuit 104 is insufficient.

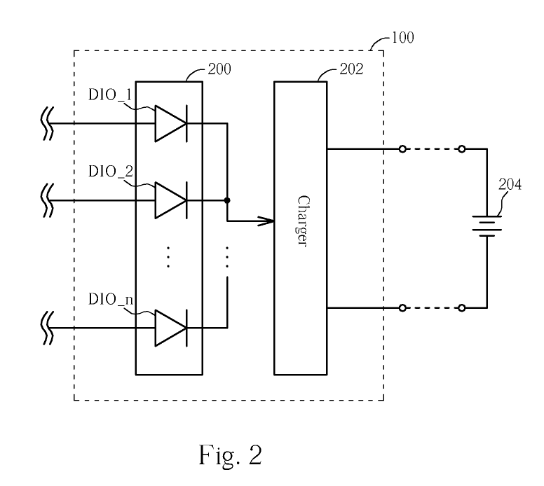

Please refer to FIG. 2, which is an illustration of a schematic diagram of a preferable embodiment of the power output unit 100. The power output unit 100 comprises a protection circuit 200 and a charger 202. The protection circuit 200 consists of diodes DIO_1˜DIO_n each coupled to one of the power generation units PWR_1˜PWR_n for preventing from too much current generated by activating the power generation units PWR_1˜PWR_n simultaneously. The charger 202 is utilized for charging a rechargeable battery 204 of the system circuit 104. Please note that FIG. 2 is only a schematic diagram of the preferable embodiment of the power output unit 100, and those skilled in the art can make appropriate modifications according to practical demands without being restricted by this embodiment.

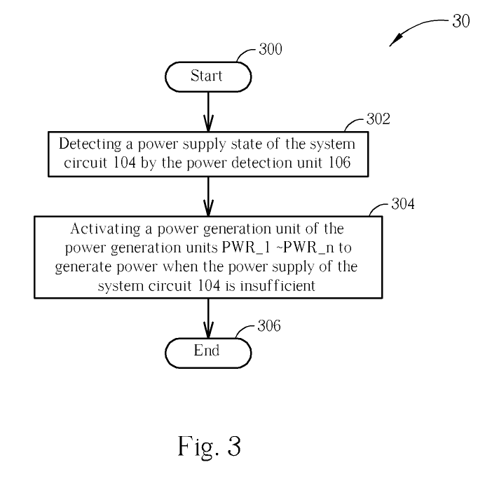

Please refer to FIG. 3, which is an illustration of a schematic diagram of a power management process 30 according to an embodiment of the present invention. The power management process 30 is utilized for controlling operations of the power supply system 10, and comprises the following steps:

Step 300: Start.

Step 302: detecting a power supply state of the system circuit 104 by the power detection unit 106.

Step 304: activating a power generation unit of the power generation units PWR_1 ˜PWR_n to generate power when the power supply of the system circuit 104 is insufficient.

Step 306: end.

According to the power management process 30, when the power detection unit 106 detects that the power supply of the system circuit 104 is insufficient (such as the rechargeable battery 204 is empty or insufficient), the present invention can activate a power generation unit from the power generation units PWR_1˜PWR_n to generate power to the power output unit 100 by the microprocessor 102, and further output power to the system circuit 104. Preferably, the microprocessor 102, which selects the appropriate power generation unit from the power generation units PWR_1˜PWR_n to generate power, is based on a current power generation condition (such as the surrounding light is sufficient or not). The current power generation condition utilizes parameters of surrounding environment of the wireless control device as references for selecting the appropriate power generation unit. The parameters of surrounding environment can be brightness, temperature, or humidity, etc. Hence, the wireless control device can install appropriate sensors accordingly for measuring the parameters. Moreover, users can set an execution order of the parameters in the microprocessor 102, so that the appropriate power generation unit can be directly selected according to the execution order. When a power generation unit PWR_1 is selected to generate power, and the power supply of the power generation unit PWR_1 is insufficient, a next appropriate power generation unit can then be selected to generate power according to the execution order of the sensing parameters. For example, if brightness of surrounding environment is set as a first sensing parameter, the present invention can firstly select an appropriate power generation unit according to the brightness magnitude. When the power supply of the selected power generation unit is insufficient, the present invention then reselects another appropriate power generation unit according to a second sensing parameter. The users can also install a selection button in the wireless control device for directly selecting an appropriate power generation unit manually. Besides, when the power detection unit 106 detects that the power supply of the system circuit 104 is insufficient, the alarm unit 108 can output an alarm signal for warning the users. Therefore, the power supply system 10 can provide power supply to the system circuit 104 timely.

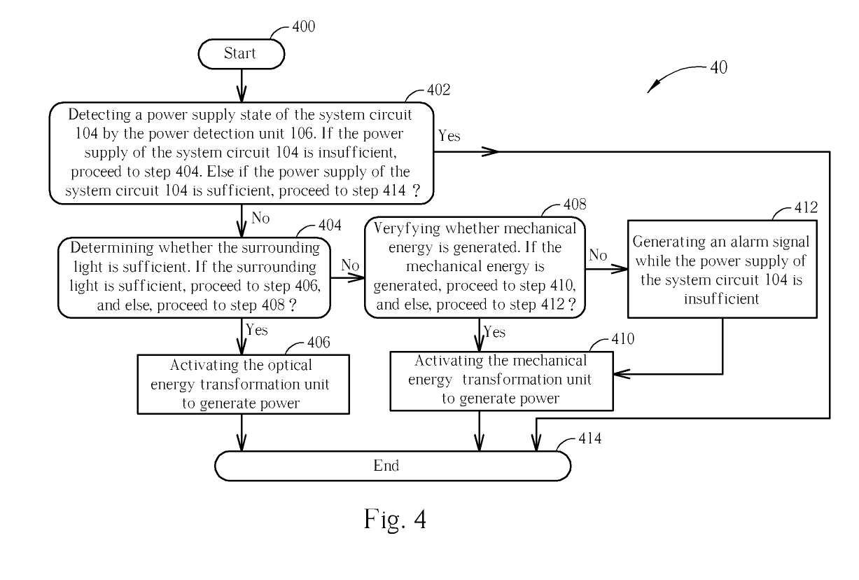

The power management process 30 shown in FIG. 3 is an embodiment of the present invention, and those skilled in the art can make appropriate modifications according to practical demands. For example, if the power generation units PWR_1˜PWR_n are a combination of a mechanical energy transformation unit and an optical energy transformation unit, the present invention can derive a power management process 40 according to the power management process 30, as shown in FIG. 4. The power management process 40 comprises the following steps:

Step 400: Start.

Step 402: detecting a power supply state of the system circuit 104 by the power detection unit 106. If the power supply of the system circuit 104 is insufficient, proceed to step 404. Else if the power supply of the system circuit 104 is sufficient, proceed to step 414.

Step 404: determining whether the surrounding light is sufficient. If the surrounding light is sufficient, proceed to step 406, and else, proceed to step 408.

Step 406: activating the optical energy transformation unit to generate power.

Step 408: verifying whether mechanical energy is generated. If the mechanical energy is generated, proceed to step 410, and else, proceed to step 412.

Step 410: activating the mechanical energy transformation unit to generate power.

Step 412: generating an alarm signal while the power supply of the system circuit 104 is insufficient.

Step 414: end.

Therefore, when the power generation units of the power supply system 10 are the combination of a mechanical energy transformation unit and an optical energy transformation unit, the present invention can automatically activate either the mechanical energy transformation unit or the optical energy transformation unit to generate electric power.

In addition, the power supply system 10 can further comprise a photo-sensing device (such as photoresistors) for generating corresponding signals to the microprocessor 102 according to light intensity to determine whether the surrounding light is sufficient or not.

Furthermore, the system circuit 104 can comprise an independent power supply device (such as batteries) for generating operation power. The related structure is well known in the art. Therefore, the detailed description will not be mentioned. As for the wireless control device in the prior art, the system of the device cannot normally operate when batteries run out. In comparison with the power supply system 10 of the present invention, the power generation units PWR_1˜PWR_n can generate electric power by means of energy transformation. Therefore, it brings more convenience for users that the present invention can generate electric power to the system circuit 104 for maintaining normal operation of the wireless control device when the power supply of the system circuit 10 is insufficient.

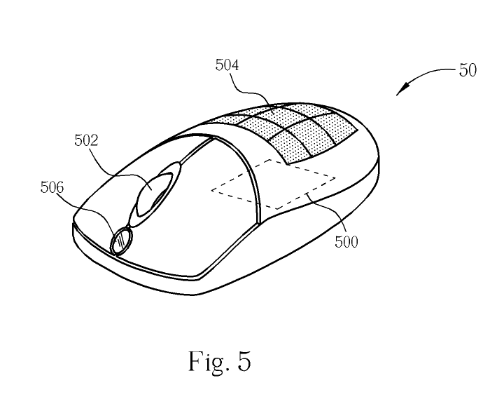

In the present invention, the power supply system 10 is used for providing power to a system circuit of a wireless control device, which is a control device incapable of acquiring power supply through physical wires, such as a wireless mouse, a wireless keyboard, etc. For example, please refer to FIG. 5, which is an illustration of a schematic diagram of a wireless mouse 50 with application of the present invention. In the wireless mouse 50, the structure of a power supply system 500 is the same with the power supply system 10. The power supply system 500 is utilized for automatically transforming mechanical energy generated by a scroll wheel 502 into electric power, or for transforming optical energy into electric power through a solar cell plate 504. Furthermore, when the power supply and the surrounding light are insufficient, and the scroll wheel 502 is not rotated, the power supply system 500 can output alarm signals through an alarm indicator 506.

By utilizing the wireless mouse 50, the users only need to move the wireless mouse 50 under sufficient light or rotate the scroll wheel 502 of the wireless mouse when the power supply is insufficient. Therefore, the wireless mouse 50 not only can be operated very friendly for users, but also can prevent from the problem of insufficient power supply. Incidentally, the wireless mouse 50 also can comprise other multi-functions. For example, the wireless mouse 50 can further comprise a data access unit for wirelessly accessing data of a corresponding computer system through the system circuit of the wireless mouse 50.

However, the wireless control device in the prior art cannot acquire demanded operation power through physical wires, and the system cannot operate normally when the batteries run out. In comparison with the prior art, the present invention can generate the demanded operation power of the wireless control device by energy transformation through a plurality of power generation units, such as mechanical energy transformation units, or optical energy transformation units, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power supply system for a wireless control device comprising:
a plurality of power generation units for generating power;
a power output unit coupled to the plurality of power generation units and a system circuit of the wireless control device for outputting power generated by the plurality of power generation units to the system circuit; and
a microprocessor coupled to the plurality of power generation units for controlling the plurality of power generation units.

2. The power supply system of claim 1, wherein a power generation unit of the plurality of power generation units is a mechanical energy transformation unit for transforming mechanical energy into electric power.

3. The power supply system of claim 1, wherein a power generation unit of the plurality of power generation units is an optical energy transformation unit for transforming optical energy into electric power.

4. The power supply system of claim 1, wherein the power output unit further comprises:
a charger for charging a battery of the system circuit; and
a protection circuit coupled between the plurality of power generation units and the charger for conducting power generated by a power generation unit of the plurality of power generation units to the charger.

5. The power supply system of claim 4, wherein the protection circuit comprises a plurality of diodes each coupled between a power generation unit of the plurality of power generation units and the charger.

6. The power supply system of claim 1 further comprising a power detection unit coupled between the microprocessor and the system circuit for detecting power of the system circuit and transmitting a detection result to the microprocessor.

7. The power supply system of claim 6 further comprising an alarm unit coupled to the power detection unit for outputting an alarm signal when the detection result of the power detection unit indicates that power supply of the system circuit is insufficient.

8. The power supply system of claim 1, wherein the wireless control device is a wireless mouse.

9. The power supply system of claim 1, wherein the wireless control device is a wireless keyboard.

10. The power supply system of claim 1, wherein the wireless control device is a personal digital assistant (PDA).

11. A power management method for a power supply system, the power supply system comprising a plurality of power generation units for generating power to a system circuit, the power management method comprising:
detecting a power supply state of the system circuit; and
activating a power generation unit of the plurality of power generation units to generate power to the system circuit when power supply of the system circuit is insufficient.

12. The power management method of claim 11, wherein activating the power generation unit of the plurality of power generation units to generate power to the system circuit when the power supply of the system circuit is insufficient is selecting the power generation unit from the plurality of power generation units to generate power according to a current power generation condition when the power supply of the system circuit is insufficient.

13. The power management method of claim 12, wherein the current power generation condition is set according to parameters of surrounding environment.

14. The power management method of claim 13, wherein the current power generation condition is set according to brightness of surrounding environment.

15. The power management method of claim 11 further comprising generating an alarm signal for indicating that the power supply of the system circuit is insufficient.

16. The power management method of claim 14, wherein activating the power generation unit of the plurality of power generation units to generate power to the system circuit when the power supply of the system circuit is insufficient is activating an optical energy transformation unit to generate power when the power supply of the system circuit is insufficient while the surrounding light is sufficient.

17. The power management method of claim 14, wherein activating the power generation unit of the plurality of power generation units to generate power to the system circuit when the power supply of the system circuit is insufficient is activating a mechanical energy transformation unit to generate power when the power supply of the system circuit and the surrounding light are insufficient.

18. A wireless mouse with power control comprising:
a system circuit for controlling a computer system through radio frequency; and
a power supply comprising:
a plurality of power generation units for generating electric power;
a power output unit coupled to the plurality of power generation units and the system circuit for outputting electric power generated by the plurality of power generation units to the system circuit; and
a microprocessor coupled to the plurality of power generation units for controlling the plurality of power generation units.

19. The wireless mouse of claim 18, wherein a power generation unit of the plurality of power generation units is a mechanical energy transformation unit for transforming mechanical energy generated by a scroll wheel into electric power.

20. The wireless mouse of claim 18, wherein a power generation unit of the plurality of power generation units is an optical energy transformation unit for transforming optical energy into electric power.

21. The wireless mouse of claim 18, wherein the power output unit comprises:
a charger for charging a battery of the system circuit; and
a protection circuit coupled between the plurality of power generation units and the charger for conducting power generated by a power generation unit of the plurality of power generation units to the charger.

22. The wireless mouse of claim 18, wherein the protection circuit comprises a plurality of diodes each coupled between a power generation unit of the plurality of power generation units and the charger.

23. The wireless mouse of claim 18 further comprising a power detection unit coupled between the microprocessor and the system circuit for detecting power of the system circuit and transmitting a detection result to the microprocessor.

24. The wireless mouse of claim 23 further comprising an alarm unit coupled to the power detection unit for outputting an alarm signal when the detection result of the power detection unit indicates that power supply of the system circuit is insufficient.

25. The wireless mouse of claim 18 further comprising a data access unit coupled to the system circuit for wirelessly accessing data of the computer system.
